(19) United States
(12) Patent Application Publication
(10) Pub. No.: US 2021/0252952 A1
(43) Pub. Date: Aug. 19, 2021

(54) Vehicle Window Shade Assembly

(71) Applicant: Celestino Manuel Iriate, Hollywood, FL (US)

(72) Inventor: Celestino Manuel Iriate, Hollywood, FL (US)

(21) Appl. No.: 16/792,677

(22) Filed: Feb. 17, 2020

(51) Int. Cl. B60J 1/20

(52) U.S. Cl. CPC B60J 1/2016; B60J 1/2052; B60J 1/2019

(57) ABSTRACT

A vehicle window shade assembly includes a plurality of roller units each positioned within a cab of a vehicle. Each of the roller units is aligned with an upper threshold of a respective one of a plurality of windows in the vehicle. A plurality of screens is each attached to a respective one of the roller units. Each of the screens is rolled onto the respective roller unit when the respective roller unit is turned on to expose the window corresponding to the respective roller unit. In this way the plurality of screens facilitates sunlight to pass through the respective window. Each of the screens is unrolled from the respective roller unit when the respective roller unit is turned off to cover the window corresponding to the respective roller unit. In this way the plurality of screens can shade an interior of the vehicle from sunlight.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to shade device and more particularly pertains to a new shade device for PURPOSE.

### (2) Description of Related Art Including Information Disclosed Under 37 CFR 1.97 and 1.98

The prior art relates to shade device.

### (h) BRIEF SUMMARY OF THE INVENTION

An embodiment of the disclosure meets the needs presented above by generally comprising a plurality of roller units each positioned within a cab of a vehicle. Each of the roller units is aligned with an upper threshold of a respective one of a plurality of windows in the vehicle. A plurality of screens is each attached to a respective one of the roller units. Each of the screens is rolled onto the respective roller unit when the respective roller unit is turned on to expose the window corresponding to the respective roller unit. In this way the plurality of screens facilitates sunlight to pass through the respective window. Each of the screens is unrolled from the respective roller unit when the respective roller unit is turned off to cover the window corresponding to the respective roller unit. In this way the plurality of screens can shade an interior of the vehicle from sunlight.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an outside perspective view of a vehicle window shade assembly according to an embodiment of the disclosure.

FIG. 2 is a front view of an embodiment of the disclosure.

FIG. 3 is a rear view of an embodiment of the disclosure.

FIG. 4 is an interior view of an embodiment of the disclosure showing a screen being rolled upwardly.

FIG. 5 is an interior cut-away view of an embodiment of the disclosure.

FIG. 6 is a schematic view of an embodiment of the disclosure.

### (j) DETAILED DESCRIPTION OF THE INVENTION

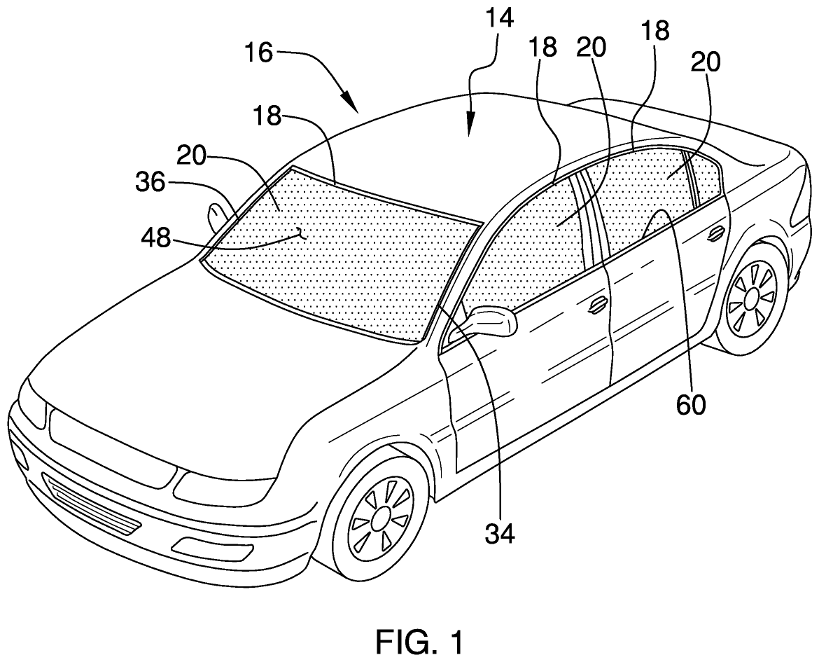

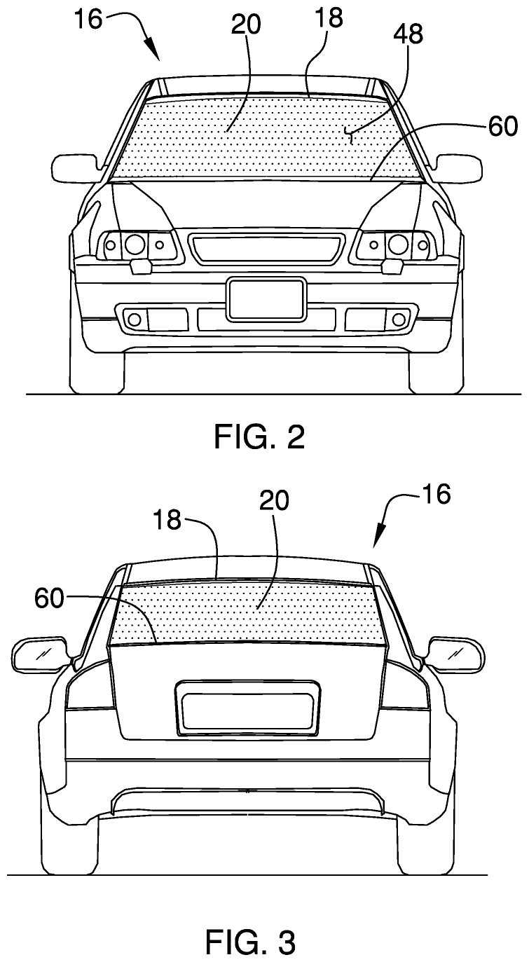

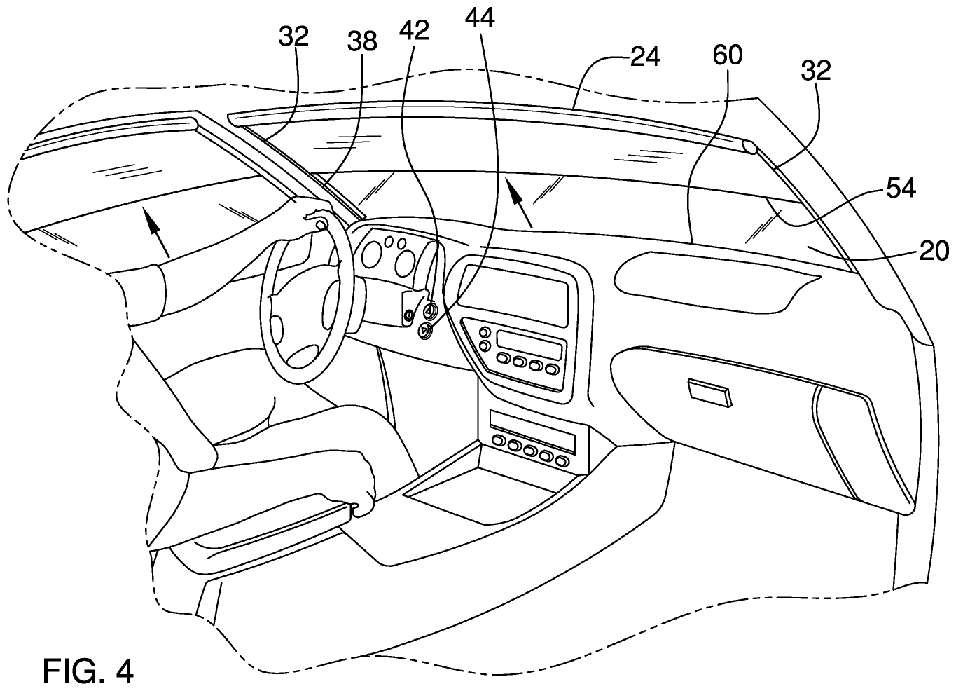

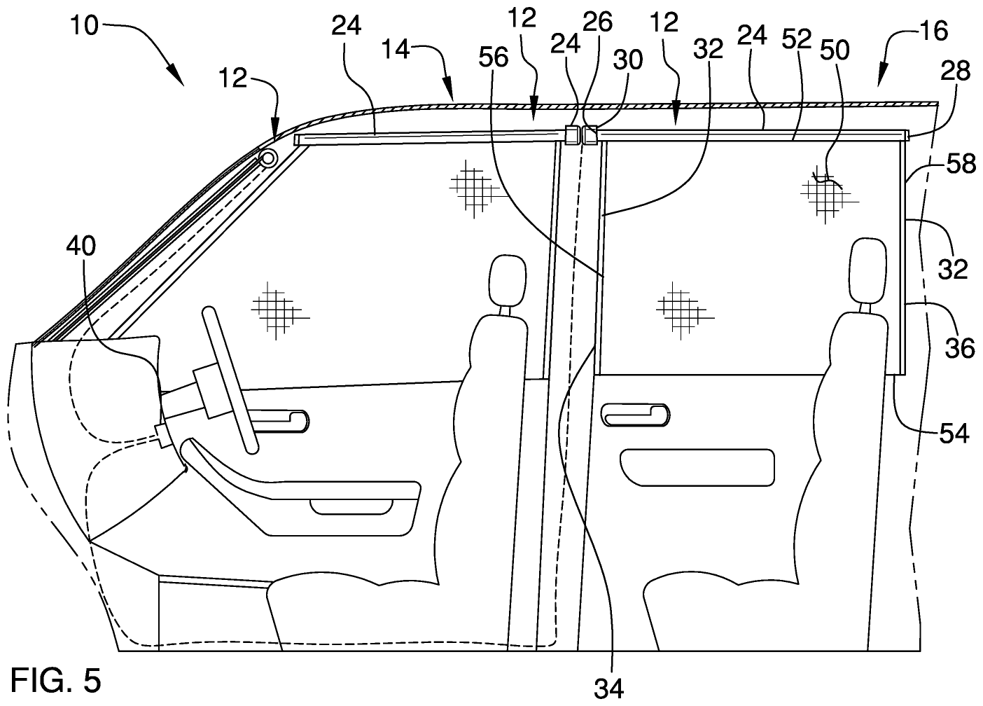

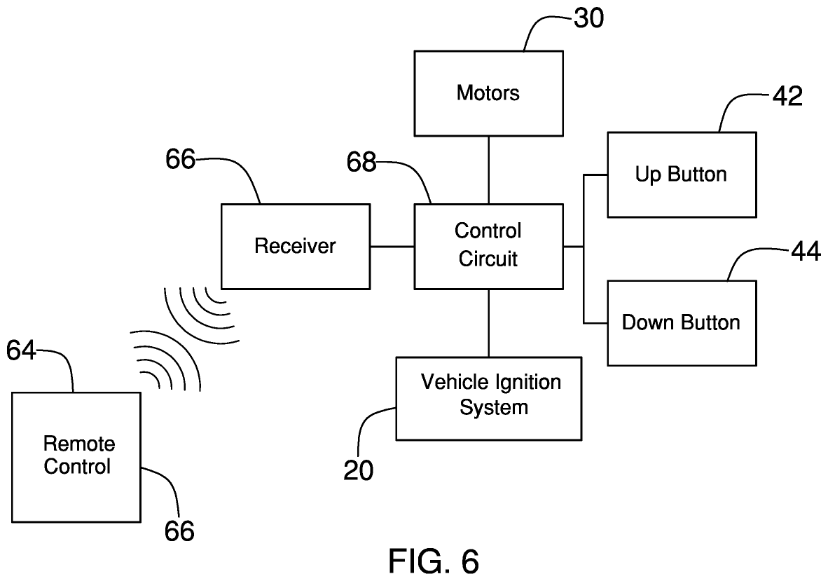

With reference now to the drawings, and in particular to FIGS. 1 through 6 thereof, a new shade device embodying the principles and concepts of an embodiment of the disclosure and generally designated by the reference numeral 10 will be described.

As best illustrated in FIGS. 1 through 6, the vehicle window shade assembly 10 generally comprises a plurality of roller units 12 and each of the roller units 12 is positioned within a cab 14 of a vehicle 16. Each of the roller units 12 is aligned with an upper threshold 18 of a respective one of a plurality of windows 20 in the vehicle 16 and each of the roller units 12 is in electrical communication with an ignition system 22 of the vehicle 16. Moreover, each of the roller units 12 is turned on or off when the ignition system 22 is turned on or off. Each of the roller units 12 rotates in a first direction when the roller units 12 are turned on and each of the roller units 12 rotates in a second direction when the roller units 12 are turned off. The vehicle 16 may be a passenger vehicle, a cargo vehicle or any other type of motorized vehicle that is driven on public roadways.

Each of the roller units 12 comprises a spool 24 that has a first end 26 and a second end 28, and the spool 24 is elongated between the first end 26 and the second end 28. Moreover, the spool 24 is horizontally positioned above the respective window 20. Each of the roller units 12 includes a motor 30 that is rotatably coupled to the first end 26 of the spool 24 and the motor 30 is electrically coupled to the ignition system 22. The motor 30 rotates in a first direction when the ignition system 22 is turned on and the motor 30 rotates in a second direction when the ignition system 22 is turned off. The motor 30 may comprise an electric motor or the like.

Each of the roller units 12 includes a pair of tracks 32 that is each vertically oriented in the vehicle 16. Moreover, each of the tracks 32 is aligned with a respective first lateral side 34 or second lateral side 36 of the respective window 20. Each of the tracks 32 has a length that is at least equal to the height the respective window 20. Additionally, each of the tracks 32 has an engaging slot 38 extending along a full length of the tracks 32.

A control 40 is positioned within the vehicle 16 such that the control 40 is accessible to a driver. The control 40 is electrically coupled to each of the roller units 12. Additionally, the control 40 turns the roller units 12 on or off regardless of whether the ignition system 22 is on or off. The control 40 comprises an up button 42 that is positioned in the vehicle 16 and the up button 42 is electrically coupled to the motor 30. The motor 30 is actuated to rotate in the first direction when the up button 42 is depressed regardless of whether the ignition system 22 is turned on. The control 40 includes a down button 44 that is positioned in the vehicle 16 and the down button 44 is electrically coupled to the motor 30. The motor 30 is actuated to rotate in the second direction when the down button 44 is depressed regardless of whether the ignition system 22 is turned off.

A plurality of screens 46 is provided and each of the plurality of screens 46 is attached to a respective one of the roller units 12. Each of the screens 46 is rolled onto the respective roller unit 12 when the respective roller unit 12 is turned on to expose the window corresponding to the respective roller unit 12. In this way the plurality of screens 46 facilitates sunlight to pass through the respective window 20. Conversely, each of the screens 46 is unrolled from the respective roller unit 12 when the respective roller unit 12 is turned off to cover the window corresponding to the respective roller unit 12. In this way the plurality of screens 46 shades an interior of the vehicle 16 from sunlight.

Each of the screens 46 has a front surface 48, a back surface 50, a top edge 52, a bottom edge 54, a first lateral edge 56 and a second lateral edge 58. The top edge 52 is coupled to the spool 24 of the respective roller unit 12 and each of the first lateral edge 56 and the second lateral edge 58 slidably engages the engaging slot 38 in a respective one of the tracks 32. The bottom edge 54 of each of the screens 46 is aligned with a lower threshold 60 of the respective window 20 when the motor 30 of the respective roller unit 12 rotates in the second direction. Conversely, the bottom edge 54 of each of the screens 46 is spaced upwardly above the upper threshold 18 of the respective window 20 when the motor 30 of the respective roller unit 12 rotates in the first direction.

The front surface 48 of each of the screens 46 is comprised of a light reflecting material to reflect sunlight. The light reflecting material may comprise a metallic coating common to window tinting. Additionally, the front surface 48 of each of the screens 46 is directed toward the respective window 20. The back surface 50 of each of the screens 46 is comprised of a light absorbing material to reflect a minimum amount of light. The back surface 50 may comprise a blackened material common to blackout curtains and the back surface 50 is directed toward the interior of the vehicle 16.

A receiver 62 is attached to the vehicle 16 and the receiver 62 is in electrical communication with the motor 30 of each of the roller units 12. A remote control 64 is provided and the remote control 64 is carried by a user. The remote control 64 includes a transmitter 66 and the transmitter 66 broadcasts a control signal to the receiver 62 for remotely controlling the motor 30 of each of the roller units 12. The receiver 62 may be a radio frequency receiver and the transmitter 66 may be a radio frequency transmitter. Additionally, the receiver 62 may include a control circuit 68 that is electrically coupled to the motor 30 of each of the rolling units 12.

In use, each of the roller units 12 rolls up the screens 46 when the ignition system 22 is turned on to start the vehicle 16. In this way the windows 20 are unobstructed while the vehicle 16 is being driven. Each of the roller units 12 rolls down the screens 46 when the ignition system 22 is turned off. In this way the interior of the vehicle 16 is shaded while the vehicle 16 is parked. The up button 42 or the down button 44 can be depressed at any time to either roll up or roll down the screens 46, regardless of whether the ignition system 22 is on or off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle window shade assembly being automatically deployed to cover a vehicle window when the vehicle is turned off, said assembly comprising:
a plurality of roller units, each of said roller units being positioned within a cab of a vehicle, each of said roller units being aligned with an upper threshold of a respective one of a plurality of windows in the vehicle, each of said roller units being in electrical communication with an ignition system of the vehicle, each of said roller units being turned on or off when the ignition system is turned on or off, each of said roller units rotating in a first direction when said roller units are turned on, each of said roller units rotating in a second direction when said roller units are turned off;
a control being positioned within the vehicle wherein said control is configured to be accessible to a driver, said control being electrically coupled to each of said roller units, said control turning said roller units on or off regardless of whether the ignition system is on or off; and
a plurality of screens, each of said screens being attached to a respective one of said roller units, each of said screens being rolled onto said respective roller unit when said respective roller unit is turned on to expose the window corresponding to said respective roller unit wherein said plurality of screens is configured to facilitate sunlight to pass through the respective window, each of said screens being unrolled from said respective roller unit when said respective roller unit is turned off to cover the window corresponding to said respective roller unit wherein said plurality of screens is configured to shade an interior of the vehicle from sunlight.

2. The assembly according to claim 1, wherein each of said roller units comprises a spool has a first end and a second end, said spool being elongated between said first end and said second end, said spool being horizontally positioned above the respective window.

3. The assembly according to claim 2, wherein each of said roller units includes a motor being rotatably coupled to said first end of said spool, said motor being electrically coupled to the ignition system, said motor rotating in a first direction when the ignition system is turned on, said motor rotating in a second direction when the ignition system is turned off.

4. The assembly according to claim 1, wherein each of said roller units includes a pair of tracks, each of said tracks being vertically oriented in the vehicle, each of said tracks being aligned with a respective first lateral side or second lateral side of the respective window, each of said tracks has an engaging slot extending along a full length of said tracks.

5. The assembly according to claim 3, wherein said control comprises an up button being positioned in the vehicle, said up button being electrically coupled to said motor, said motor being actuated to rotate in said first direction when said up button is depressed regardless of whether the ignition system is turned on.

6. The assembly according to claim 3, wherein said control comprises a down button being positioned in the vehicle, said down button being electrically coupled to said motor, said motor being actuated to rotate in said second direction when said down button is depressed regardless of whether the ignition system is turned off.

7. The assembly according to claim 4, wherein each of said screens has a front surface, a back surface, a top edge, a bottom edge, a first lateral edge and a second lateral edge, said top edge being coupled to a spool of said respective roller unit, each of said first lateral edge and said second lateral edge slidably engaging said engagement slot in a respective one of said tracks.

8. The assembly according to claim 7, wherein said bottom edge of each of said screens is aligned with a lower threshold of the respective window when said motor of said respective roller unit rotates in said second direction, said bottom edge of each of said screens being spaced upwardly above the upper threshold of the respective window when said motor of said respective roller unit rotates in said first direction.

9. The assembly according to claim 7, wherein said front surface is comprised of a light reflecting material wherein said front surface is configured to reflect sunlight, said front surface being directed toward the respective window.

10. The assembly according to claim 7, wherein said back surface is comprised of a light absorbing material wherein said back surface is configured to reflect a minimum amount of light, said back surface being directed toward the interior of the vehicle.

11. A vehicle window shade assembly being automatically deployed to cover a vehicle window when the vehicle is turned off, said assembly comprising:
a plurality of roller units, each of said roller units being positioned within a cab of a vehicle, each of said roller units being aligned with an upper threshold of a respective one of a plurality of windows in the vehicle, each of said roller units being in electrical communication with an ignition system of the vehicle, each of said roller units being turned on or off when the ignition system is turned on or off, each of said roller units rotating in a first direction when said roller units are turned on, each of said roller units rotating in a second direction when said roller units are turned off, each of said roller units comprising:
a spool has a first end and a second end, said spool being elongated between said first end and said second end, said spool being horizontally positioned above the respective window;
a motor being rotatably coupled to said first end of said spool, said motor being electrically coupled to the ignition system, said motor rotating in a first direction when the ignition system is turned on, said motor rotating in a second direction when the ignition system is turned off; and
a pair of tracks, each of said tracks being vertically oriented in the vehicle, each of said tracks being aligned with a respective first lateral side or second lateral side of the respective window, each of said tracks has an engaging slot extending along a full length of said tracks;
a control being positioned within the vehicle wherein said control is configured to be accessible to a driver, said control being electrically coupled to each of said roller units, said control turning said roller units on or off regardless of whether the ignition system is on or off, said control comprising:
an up button being positioned in the vehicle, said up button being electrically coupled to said motor, said motor being actuated to rotate in said first direction when said up button is depressed regardless of whether the ignition system is turned on; and
a down button being positioned in the vehicle, said down button being electrically coupled to said motor, said motor being actuated to rotate in said second direction when said down button is depressed regardless of whether the ignition system is turned off;
a plurality of screens, each of said screens being attached to a respective one of said roller units, each of said screens being rolled onto said respective roller unit when said respective roller unit is turned on to expose the window corresponding to said respective roller unit wherein said plurality of screens is configured to facilitate sunlight to pass through the respective window, each of said screens being unrolled from said respective roller unit when said respective roller unit is turned off to cover the window corresponding to said respective roller unit wherein said plurality of screens is configured to shade an interior of the vehicle from sunlight, each of said screens has a front surface, a back surface, a top edge, a bottom edge, a first lateral edge and a second lateral edge, said top edge being coupled to said spool of said respective roller unit, each of said first lateral edge and said second lateral edge slidably engaging said engagement slot in a respective one of said tracks, said bottom edge of each of said screens being aligned with a lower threshold of the respective window when said motor of said respective roller unit rotates in said second direction, said bottom edge of each of said screens being spaced upwardly above the upper threshold of the respective window when said motor of said respective roller unit rotates in said first direction, said front surface being comprised of a light reflecting material wherein said front surface is configured to reflect sunlight, said front surface being directed toward the respective window, said back surface being comprised of a light absorbing material wherein said back surface is configured to reflect a minimum amount of light, said back surface being directed toward the interior of the vehicle;
a receiver being attached to the vehicle, said receiver being in electrical communication with said motor of each of said roller units; and
a remote control being carried by a user, said remote control including a transmitter, said transmitter broadcasting a control signal to said receiver for remotely controlling said motor of each of said roller units.
